(19) United States
(12) Patent Application Publication
(10) Pub. No.: US 2010/0299941 A1
(43) Pub. Date: Dec. 2, 2010

(54) Fishing Line Cutter with Knot Locator and Soft Mounting Base

(76) Inventor: Brad Marlin, (US)

Correspondence Address: Brad Marlin;Marlin Gear Ltd., 4645 Kearse St., Burlington, L7M 0E9, omitted

(21) Appl. No.: 12/709,653

(22) Filed: Feb. 22, 2010

Related U.S. Application Data
(60) Provisional application No. 61/157,774, filed on Mar. 5, 2009.

(51) Int. Cl. A01K 97/00

(52) U.S. Cl. 30/296.1

(57) ABSTRACT

A fishing line cutter with a soft mounting base with two protruding fins that straddle the fishing rod, a strap that secures the fishing line cutter to the mounting base and also secures the protruding fins to the fishing rod, a ridge that protrudes parallel to the cutting blade within the line cutting channel that allows location and cutting of the knot, and a hole on the top of the unit for attaching hooks and lures.

### CROSS REFERENCE TO RELATED APPLICATIONS

This application is based on provisional application Ser. No. 61/157,774, filed on Mar. 5, 2009.

### STATEMENT REGARDING FEDERALLY SPONSORED RESEARCH OR DEVELOPMENT

Not Applicable

### DESCRIPTION OF ATTACHED APPENDIX

Not Applicable

### FIELD OF THE INVENTION

This invention relates generally to the field of fishing line cutters that attach to fishing rods.

### DESCRIPTION OF RELATED ART

The prior art discloses a variety of fishing line cutters that mount to fishing rods which have blades for cutting line. Although the prior art teaches line cutters which are attachable to a fishing rod, there is no teaching of which the Applicant is aware of a line cutter which is secured to a rod with a flexible mounting base with protruding fins and a hook-and-loop strap that will not blemish or damage the rod, and will be secure enough to tolerate high line tension during cutting of braided or fused poly-filament line. Having failed to recognize these problems, the prior art does not address or solve them. Also, the prior art does not recognize or address any problems associated with locating and cutting the fishing knot. The prior art also does not recognize or address any problems associated with securing the hook during rod transport and storage.

The following prior art is disclosed:
U.S. Pat. No(s). 4,023,299; 4,726,140; 5,182,874; 4,896,422; 4,823,498

There has been a long need for an effective and efficient rod-mountable fishing line cutter that is capable of cutting advanced fishing lines such as braid and fused poly-filament. There has been a long need for a fishing line cutter that can be mounted securely yet does not damage the finish of a fishing rod. There has been a long need for a fishing line cutter that does not slip along or off the rod when casting or cutting. There has been a long need for a fishing line cutter that can locate and cut the knot between the line and the lure.

### SUMMARY OF THE PRESENT INVENTION

In accordance with a preferred embodiment of the invention, there is disclosed an apparatus that mounts to a fishing rod and cuts fishing line comprising: a soft, pliable mounting base with two protruding fins that straddle the fishing rod, a strap that secures the fishing line cutter to the mounting base and also secures the protruding fins to the fishing rod, a ridge that protrudes along the underside of the line cutting channel that allows a fisherman to locate the knot by running fishing line in the channel under tension, and a hole on the top of the unit for attaching hooks and lures.

The present invention consists of main cutting unit comprising a body with a base and shield forming a channel containing a cutting blade that permits the passage of fishing line but not human fingers. The fisherman cuts the fishing line by holding the lure with one hand and the line in the other, guiding the line under tension in the cutting channel between the base and the shield. While the fishing line is within the cutting channel, he pulls both hands up which puts the line against the underside of the shield. Within the channel is a ridge that protrudes along the underside of the shield that allows the fisherman to feel and subsequently guide the knot of the fishing line towards the cutting blade under high tension. As the knot is pulled upwards and backwards simultaneously, it runs along the length of the blade until it is cut. The body is seated on a soft, pliable mounting base with two flexible fins which straddle and wrap around fishing rods of varying diameters when used in combination of a hook and loop fastening strap. The mounting base prevents the fishing line cutter from detaching or sliding on the fishing rod, allowing the fisherman to apply leverage by providing high tension to the line and the shield while sliding back towards the blade, thereby cutting the line. There is a hole at the tip of the shield where fishermen can store their hooks and lures during transport or storage.

The primary object of the present invention is to provide a fishing line cutter capable of cutting advanced braided or fused poly-filament fishing lines.

Another object of the invention is to provide a fishing line cutter that mounts to a wide variety of fishing rod diameters.

A further object of the invention is to provide a fishing line cutter that is removable, fastens securely, does not slip off or slide along the fishing rod during use, and will not harm the finish of the fishing rod.

Yet another object of the invention is to provide a fishing line cutter that allows a fisherman to locate and cut the knot of a fishing line by touch.

Still yet another object of the invention is to provide a fishing line cutter that allows a fisherman to secure his lure or hook safely during transport.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a fishing line cutter according to the present invention

FIG. 2 is a side view of a fishing line cutter according to the present invention

FIG. 3 is a bottom view of a fishing line cutter according to the present invention

FIG. 4 is a front view of a fishing line cutter according to the present invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

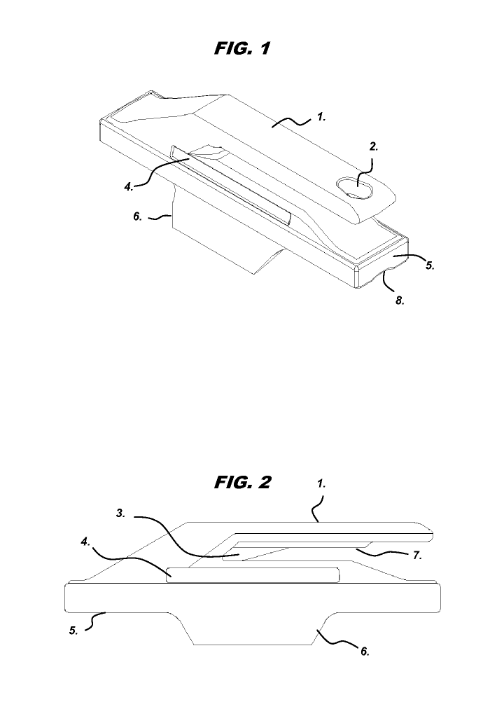

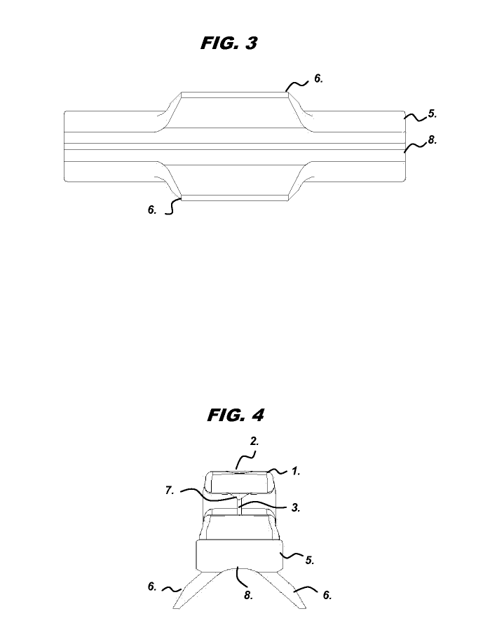

Referring now to the invention in more detail, in FIG. 1 to FIG. 4 there is shown a fishing line cutter having a cutting blade 3, a shield 1, a mounting base 5 and two flexible mounting fins 6 and mounting groove 8 along with a protruding ridge 7 on the underside of the shield 1. Referring now to the invention in more detail, in FIG. 1 to FIG. 4 there is shown a fishing line cutter having a mounting slot 4 where a strap (not shown) that passes through to secure the fishing line cutter including bending flexible fins 6 of the mounting base 5 to the contours of a fishing rod. Referring now to the invention in more detail, the strap (not shown) passes through the mounting slot 4 and wraps around the flexible fins 6 and secures the fishing line cutter and mounting base securely in place on the fishing rod.

Referring now to the invention in more detail in FIG. 1 to FIG. 4, there is shown a fishing line cutter having a hole 2 for securing hooks and lures while attached to fishing line under tension. In further detail, still referring to the invention of FIG. 1 to FIG. 4 the shield 1 is of sufficient width and distance from the cutting blade 3 to allow fishing line and knot to pass through but insufficient width and distance from the cutting blade 3 to allow human fingers to make contact with the cutting blade 3.

The construction details of the invention as shown in FIG. 1 to FIG. 4 are that the fishing line cutter is made of plastic composite or metal alloy, the cutting blade 3 is made of stainless steel or steel composite for effective cutting of fishing line, and the mounting base 5 and fins 6 are made of soft pliable compound to maximize friction between the mounting base and a fishing rod without abrasion. The advantages of the present invention include, without limitation, a protruding ridge 7 that allows a fishermen to locate the knot by touch as he runs the line and knot towards the cutting blade 3; a secure method of strapping the fishing line cutter to a wide variety of fishing rod diameters in a manner that does not damage the fishing rod during use, and that prevents slippage during cutting or casting of the fishing rod.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A fishing line cutter that attaches to a fishing rod comprising:
a soft, pliable mounting base with two protruding fins that straddle the rod,
a strap that secures the fishing line cutter to the mounting base and secures the protruding fins to the fishing rod.

2. A fishing line cutter recited in claim 1 with ridge that protrudes parallel to the plane of the cutting blade in the cutting channel formed by a base and shield.

3. The fishing line cutter recited in claim 1 with a hole through the top of the shield.
